(19) United States
(12) Patent Application Publication
(10) Pub. No.: US 2021/0406460 A1
(43) Pub. Date: Dec. 30, 2021

(54) Conference speech management method and apparatus

(71) Applicant: SHENZHEN EAGLESOUL TECHNOLOGY CO., LTD., Shenzhen (CN)

(72) Inventors: Yingxi CHEN, Shenzhen (CN); Ning YANG, Dalian (CN); Kai TENG, Dalian (CN)

(21) Appl. No.: 16/467,460

(22) PCT Filed: Jun. 26, 2018
(86) PCT No.: PCT/CN2018/092781

§ 371 Date: Jun. 6, 2019

(30) Foreign Application Priority Data
Apr. 26, 2018 (CN) 201810386968.0

(51) Int. Cl. G06F 40/205; G06F 40/166; G06F 40/40; G06Q 10/10

(52) U.S. Cl. CPC G06F 40/205; G06Q 10/109; G06F 40/40; G06F 40/166

(57) ABSTRACT

The present disclosure relates to a conference speech management method and apparatus, and an electronic device and a computer readable storage medium. The method comprises: acquiring conference contents, generating a conference content summary according to the conference contents, broadcasting and sending the conference content summary to participants, receiving conference summary identifier information sent by the participants, marking the participants who send the conference summary identifier information as participants-to-speak, wherein the conference summary identifier information comprises the speech mark information added by the participants-to-speak in the conference content summary and the identity information of the participants-to-speak, parsing and counting the conference summary identifier information, and generating, according to the conference summary identifier information, a speech sequence of the participants-to-speak in a conference discussion. The present disclosure can generate a speech sequence of the participants by means of identification processing of the conference summary identifier information.

### CROSS-REFERENCE TO RELATED APPLICATIONS

This application is a national stage application of PCT Application No. PCT/CN2018/092781. This application claims priority from PCT Application No. PCT/CN2018/092781, filed Jun. 26, 2018, and CN Application No. 201810386968.0, filed Apr. 26, 2018, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### TECHNICAL FIELD

The present disclosure relates to the technical field of computers, and in particular to a conference speech management method and apparatus, and an electronic device and a computer readable storage medium.

### BACKGROUND ART

In addition to a formal speech session, a conference will also have a discussion session regarding contents determined according to the contents of the aforementioned formal speech session. During this session, different participants express their own views and opinions on the conference contents, which not only supplements the conference contents, but also completes and improves the conference contents, and is an important session of the conference.

However, in the actual discussion session, the existing general participants will speak to participate in the discussion in sequence according to the order of their seats, however, because different participants place emphasis on different parts of the conference contents, the speeches will be fragmented and chaotic, and will not better serve the purpose of discussion and speeches; or, the participants will speak according to the their social status, if organization is not realized, they will be courteous to each other, and the courteous concessions will also consume valuable conference time.

In the prior art, the invention patent application with application number CN 201310684747.9 discloses a video conference method, which generates a list of speech sequences by acquiring a speech request of at least one participant. The method completely sorts the speech sequences in accordance with the sequence based on the participants' speech requests, rather than following the logical sequence of the conference contents. Such a method is consistent with the effect in the prior art of speaking in accordance with the seat numbers of participants, and cannot solve the problem of the logical inconsistency of multiple speakers.

The invention patent application with application number CN 201410211393.0 discloses an informationized intelligent conference scheduling management device and a method of using same. The intelligent scheduling of the conference is realized using a microphone provided with an identity card interface, thus avoiding the phenomenon of grabbing microphones. The method optimizes the speakers' speech behaviors, rather than adjusting the speech sequence according to the conference contents.

The invention patent application with application number CN201611039654.0 discloses a control method, a system and an electronic device for group chatting, which realize the adjustment of the total speech sequence by means of the expected customization of the duration of each speaker's speech. The method aims to solve the problem of simultaneous speeches of multiple speakers during multiple-speaker teleconferencing, rather than pre-adjusting the speech sequence of different speakers based on the conference contents.

Therefore, there is a need to provide one or more technical solutions that at least can solve the above-mentioned problems.

It should be noted that the information disclosed in the section “Background Art” above is only used to strengthen the understanding of the background of the present disclosure, and thus may include information that does not constitute prior art known to a person skilled in the art.

### SUMMARY OF THE INVENTION

The purpose of the present disclosure is to provide a conference speech management method and apparatus, an electronic device, and a computer readable storage medium, thereby at least overcoming, to a certain extent, one or more problems caused by the limitations and defects of the related art.

According to one aspect of the present disclosure, a conference speech management method is provided, comprising:

a conference content acquisition step for acquiring conference contents and generating a conference content summary according to the conference contents;

a conference summary broadcast step for broadcasting and sending the conference content summary to participants;

an identifier information receiving step for receiving conference summary identifier information sent by participants, marking the participants who send the conference summary identifier information as participants-to-speak, wherein the conference summary identifier information comprises speech mark information added by the participants-to-speak in the conference content summary and the identity information of the participants-to-speak; and

a speech sequence generating step for parsing and counting the conference summary identifier information, and generating, according to the conference summary identifier information, a speech sequence of the participants-to-speak in a conference discussion.

In one exemplary embodiment of the present disclosure, broadcasting and sending the conference content summary to participants comprises:

acquiring conference agenda information;

identifying time information in the conference agenda information;

generating, according to the conference agenda information and pre-stored conference content, a conference content summary of a specified part;

determining specified time information in the conference agenda information corresponding to the conference content summary of the specified part;

setting a timer according to the specified time information; and

broadcasting, after a timing duration of the timer expires, the conference content summary of the specified part to the participants.

In one exemplary embodiment of the present disclosure, the parsing and counting the conference summary identifier information comprises:

identifying the speech mark information added by the participants-to-speak in the conference content summary, and determining, according to the speech mark information, text positions of speech contents to be spoken by the participants-to-speak in the conference content summary; and

counting the conference summary identifier information sent by all the participants-to-speak, and generating a sequence of speakers according to a position sequence of the text positions of the speech contents to be spoken by the participants-to-speak in the conference content summary.

In one exemplary embodiment of the present disclosure, the parsing and counting the conference summary identifier information comprises:

adding receive time stamps to the conference summary identifier information sent by all the participants-to-speak; and

counting the conference summary identifier information sent by all the participants-to-speak, and if it is determined that the text positions of the speech contents to be spoken by a plurality of the participants-to-speak in the conference content summary are the same, according to a time sequence of the receive time stamps, performing sorting of the sequence of speakers on the conference summary identifier information of the plurality of the participants-to-speak having the same text position in the speech contents.

In one exemplary embodiment of the present disclosure, the method further comprises:

acquiring the speech mark information added by the participants-to-speak in the conference content summary and the identity information of the participants-to-speak from the conference summary identifier information;

establishing correspondence relationships between speech mark information of the participants-to-speak, the identity information of the participants-to-speak and the sequence of speakers; and

sending the correspondence relationships to the corresponding participants-to-speak.

In one exemplary embodiment of the present disclosure, sending the correspondence relationships to the corresponding participants-to-speak comprises:

sending, according to the identity information of the participants-to-speak in the correspondence relationships, the sequence of speakers and speech confirmation information to the participants-to-speak; and

after receiving speech response instructions replied by the participants-to-speak, adjusting the sequence of speakers according to the speech response instructions.

In one exemplary embodiment of the present disclosure, the method further comprises:

looking up, from the sequence of speakers, participants-to-speak whose numbers of speeches are greater than or equal to a preset number of times; and

organizing all the speech mark information of the participants-to-speak whose numbers of speeches are greater than or equal to the preset number of times in the correspondence relationships, and deleting, from the speaker sequence, non-first speech sequence of the participants-to-speak whose numbers of speeches in the correspondence relationships are greater than or equal to the preset number of times.

In one exemplary embodiment of the present disclosure, the method further comprises:

acquiring preset conference agenda information, and identifying time information in the conference agenda information; and

generating, according to the conference agenda information and pre-stored conference content, a conference content summary of a specified part;

establishing a conference discussion group corresponding to the conference content summary of the specified part;

identifying the speech mark information added by the participants-to-speak in the conference content summary, and determining, according to the speech mark information, text positions of speech contents to be spoken by the participants-to-speak in the conference content summary; and

counting the conference summary identifier information sent by all the participants-to-speak, and assigning the participants-to-speak for the speech mark information added in the conference content summary of the same specified part to a same discussion group.

In one exemplary embodiment of the present disclosure, generating, according to the conference summary identifier information, a speech sequence of the participants-to-speak in a conference discussion comprises:

acquiring the identity information of the participants-to-speak and preset conference agenda information, the conference agenda information including identity identifiers of the participants and a sequence of arrangement;

counting information of all the participants-to-speak;

matching the information of all the participants-to-speak with the conference agenda information; and

performing speaker sorting on all the participants-to-speak according to the identity identifiers of the participants and the sequence of arrangement of the participants in the preset conference agenda information.

In one aspect of the present disclosure, a conference speech management apparatus is provided, comprising:

a conference content acquisition module for acquiring conference contents and generating a conference content summary according to the conference contents;

a conference summary broadcast module for broadcasting and sending the conference content summary to participants;

an identifier information receiving module for receiving conference summary identifier information sent by the participants, marking the participants who send the conference summary identifier information as participants-to-speak, wherein the conference summary identifier information comprises speech mark information added by the participants-to-speak in the conference content summary and the identity information of the participants-to-speak; and

a speech sequence generating module for parsing and counting the conference summary identifier information, and generating, according to the conference summary identifier information, a speech sequence of the participants-to-speak in a conference discussion.

In one aspect of the present disclosure, an electronic device is provided, comprising:

a processor; and

a memory having stored thereon computer readable instructions that, when executed by the processor, implement the method as described in any one of the above.

In one aspect of the present disclosure, a computer readable storage medium is provided, having stored thereon a computer program that, when executed by a processor, implements the method as described in any one of the above.

The conference speech management method in an exemplary embodiment of the present disclosure comprises: acquiring conference contents, generating a conference content summary according to the conference contents, broadcasting and sending the conference content summary to participants, receiving conference summary identifier information sent by the participants, marking the participants who send the conference summary identifier information as participants-to-speak, wherein the conference summary identifier information comprises the speech mark information added by the participants-to-speak in the conference content summary and the identity information of the participants-to-speak, parsing and counting the conference summary identifier information, and generating, according to the conference summary identifier information, a speech sequence of the participants-to-speak in a conference discussion. On the one hand, a speech sequence of the participants is automatically generated by means of identification processing of the conference summary identifier information, thereby simplifying the conference organization process and optimizing the conference management mode; and on the other hand, through the introducing of optimization logic for identifying the identity identifiers of the participants-to-speak of the conference and adjusting the sequence of multiple speeches, the speech sequence of the conference thus generated is fair and reasonable, and has rules to follow, which not only avoids the phenomenon that the speakers in the common meetings are courteous to each other in presenting a speech, but also enables the participants to choose to participate with preference in the conference according to the speech sequence, thereby enhancing the user experience.

It should be understood that the above general description and the following detailed description are merely exemplary and illustrative, and should not limit the pre sent disclosure.

### BRIEF DESCRIPTION OF THE DRAWINGS

The above-mentioned and other features and advantages of the present disclosure will become more apparent through the description of exemplary embodiments thereof in detail with reference to the accompanying drawings.

FIG. 1 shows a flowchart of a conference speech management method according to one exemplary embodiment of the present disclosure;

FIG. 2 shows a schematic diagram of a keyword marking operation in a conference summary according to one exemplary embodiment of the present disclosure;

FIG. 3 shows a schematic diagram of an application scenario for the conference speech management method according to one exemplary embodiment of the present disclosure;

FIG. 4 shows a schematic block diagram of a conference speech management apparatus according to one exemplary embodiment of the present disclosure;

FIG. 5 schematically shows a block diagram of an electronic device according to one exemplary embodiment of the present disclosure; and

FIG. 6 schematically shows a schematic diagram of a computer readable storage medium in accordance with one exemplary embodiment of the present disclosure.

### DETAILED DESCRIPTION

The exemplary embodiments will now be described more fully with reference to the accompanying drawings. However, the exemplary embodiments can be implemented in various forms and should not be construed as being limited to the embodiments set forth herein; rather, these embodiments are provided so that the present disclosure will be thorough and complete, and the concept of the exemplary embodiments is fully delivered to a person skilled in the art. The same reference numerals in the drawings denote the same or similar components, and thus the repeated description thereof will be omitted.

In addition, the described features, structures, or characteristics may be combined, in any suitable manner, in one or more embodiments. In the following description, numerous specific details are provided to give a thorough understanding of the embodiments of the present disclosure. However, a person skilled in the art will appreciate that the technical solution of the present disclosure may be practiced without one or more of the specific details, or by using other methods, components, materials, apparatuses, steps, etc. In other circumstances, the well-known structures, methods, apparatuses, implementations, materials, or operations are not shown or described in detail to avoid obscuring various aspects of the present disclosure.

The block diagrams shown in the drawing are merely functional entities and do not necessarily have to correspond to physically independent entities. That is, these functional entities may be implemented in the form of software, or these functional entities or some of the functional entities may be implemented in one or more software-hardened modules, or these functional entities may be implemented in different networks and/or processor apparatuses and/or microcontroller apparatuses.

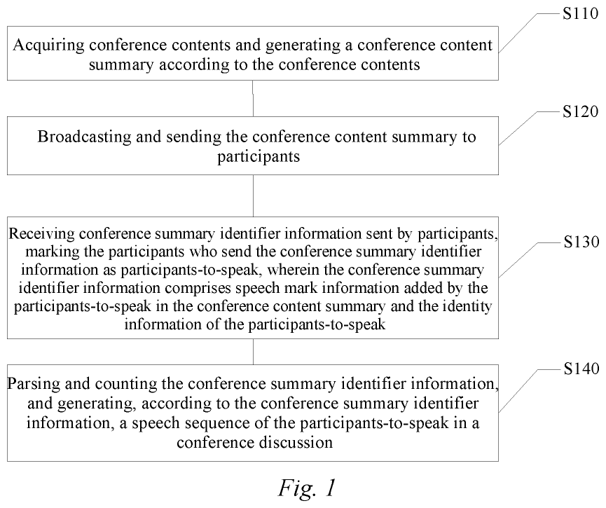

In this exemplary embodiment, there is first provided a conference speech management method, which can be applied to an electronic device such as a computer. With reference to FIG. 1, the conference speech management method may comprise the following steps:

a conference content acquisition step S110 for acquiring conference contents and generating a conference content summary according to the conference contents;

a conference summary broadcast step S120 for broadcasting and sending the conference content summary to participants;

an identifier information receiving step S130 for receiving conference summary identifier information sent by participants, marking the participants who send the conference summary identifier information as participants-to-speak, wherein the conference summary identifier information comprises speech mark information added by the participants-to-speak in the conference content summary and the identity information of the participants-to-speak; and

a speech sequence generating step S140 for parsing and counting the conference summary identifier information, and generating, according to the conference summary identifier information, a speech sequence of the participants-to-speak in a conference discussion.

According to the conference speech management method in this exemplary embodiment, on the one hand, a speech sequence of the participants is automatically generated by means of identification processing of the conference summary identifier information, thereby simplifying the conference organization process and optimizing the conference management mode; and on the other hand, through the introducing of optimization logic for identifying the identity identifiers of the participants-to-speak of the conference and adjusting the sequence of multiple speeches, the speech sequence of the conference thus generated is fair and reasonable, and has rules to follow, which not only avoids the phenomenon that the speakers in the common meetings are courteous to each other in presenting a speech, but also enables the participants to choose to participate with preference in the conference according to the speech sequence, thereby enhancing the user experience.

The conference speech management method in this exemplary embodiment will be further described below.

In a conference content acquisition step S110, conference contents can be acquired and a conference content summary according to the conference contents can be generated.

In this exemplary embodiment, in a general conference, a discussion session is performed after the end of the conference content paragraph or after the end of all the contents, and how to determine the sequence of speakers of the conference during the discussion is the problem to be solved by the method of the present invention.

In this exemplary embodiment, generating a conference content summary according to the collection of the conference content information is a primary session of determining the sequence of speakers of the conference, and is a necessary step for conference management. It is only on the basis of determining the conference content summary, that the identifier information and identity information of the speakers can be further consolidated, thereby generating the speaker sequence. There are many ways to generate the conference content summary according to the conference contents: the conference content summary can be generated according to the preset content of the conference agenda combined with the conference time, the conference participants, and the like; alternatively, it is also possible to intelligently generate the conference summary according to the digital collection and analysis of the conference contents.

In this exemplary embodiment, generating the conference content summary according to the conference contents comprises: determining a high frequency word in the conference content which has a frequency greater than a preset threshold value, and using the high frequency word as a conference keyword; generating keyword vectors using the conference keyword, the keyword vectors representing keyword relevance of the keyword in various dimensions; and calculating projection lengths of the keyword vectors, and generating the conference summary according to a keyword vector with the longest projection length. The method for generating the conference content summary according to the conference content generates keyword vectors in various dimensions, and generates the conference summary by calculating a keyword with the longest projection length, which can strongly fit the conference theme and improve the accuracy of the generated conference summary, and which is more suitable for the conference speech management method for determining the conference speaker sequence by means of the conference content summary.

In a conference summary broadcast step S120, the conference content summary can be broadcast and sent to participants.

In this exemplary embodiment, after the conference content summary is generated according to the conference contents, the conference content summary is sent to a conference receiving terminal of each participant, wherein the conference receiving terminal may be a preset conference information receiving device specifically for the conference, or may also be an information receiving device of the participant his or her own, such as a laptop computer, a pad computer or a mobile phone, which accesses a the specified network or is connected by specific software, and which can be used for receiving the broadcast of the conference content summary.

In this example embodiment, broadcasting and sending the conference content summary to participants comprises: acquiring conference agenda information; identifying time information in the conference agenda information; generating, according to the conference agenda information and pre-stored conference content, a conference content summary of a specified part; determining specified time information in the conference agenda information corresponding to the conference content summary of the specified part; setting a timer according to the specified time information; and broadcasting, after a timing duration of the timer expires, the conference content summary of the specified part to the participants. The conference content summary of the corresponding conference contents which is generated together according to the time information in the conference agenda information and pre-stored conference contents combines the conference time information and the conference content combined together, thereby realizing the segmentation and broadcasting by paragraphs of the conference summary by the participant according to the conference content time. In this way, the participant can mark the contents they are interested in or have doubts about in time to facilitate the discussion in the later discussion session, and the conference time and the conference content can be consolidated, so as to facilitate the counting of the conference summary identifier information of the participant. The time of the timer may be a short time, which allows the participant to receive the generated conference summary almost in real time, or the conference summary may be broadcast to the participant by paragraphs in accordance with preset paragraph time in the conference agenda.

In an identifier information receiving step S130, conference summary identifier information sent by the participants can be received, the participants who send the conference summary identifier information can be marked as participants-to-speak, wherein the conference summary identifier information comprises the speech mark information added by the participants-to-speak in the conference content summary and the identity information of the participants-to-speak.

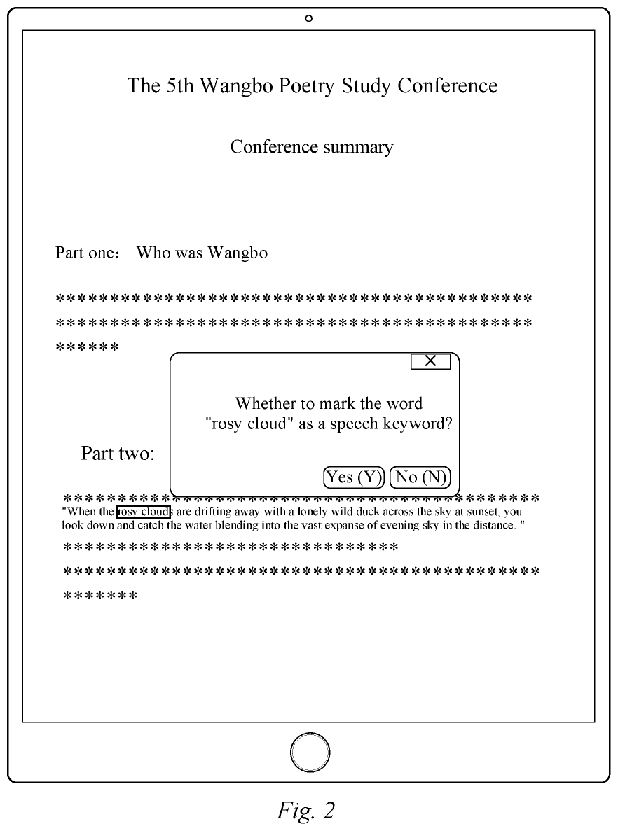

In this exemplary embodiment, regardless of whether the participant receives the conference summary in real time or by paragraphs, they will mark the speech points that need to be discussed in the discussion session according to their own understanding, so as to determine the points to be spoken in the discussion session. As long as the participant adds the speech mark information to the conference summary, the participant is marked as a participant-to-speak, and the conference summary identifier information is generated according to the speech mark information added to the conference summary and the identity information of the participant-to-speak. Adding the speech mark information to the conference summary may take the form of a circle frame, an underline, or the like on the keywords in the conference summary, or may be performed by clicking a keyword to be marked, and then the marking operation is confirmed. As shown in FIG. 2, an operation schematic diagram for marking the keyword “rosy cloud” in the conference summary in a certain conference speech is shown.

In a speech sequence generating step S140, the conference summary identifier information can be parsed and counted, and according to the conference summary identifier information, a speech sequence of the participants-to-speak in a conference discussion can be generated.

In this exemplary embodiment, the conference summary identifier information sent by the participants-to-speak is received and parsed, data counting is performed on all the conference summary identifier information, and a speech sequence of the participants-to-speak in the conference discussion is generated according to the result of the data counting.

In this exemplary embodiment, the parsing and counting of the conference summary identifier information comprises: identifying the speech mark information added by the participants-to-speak in the conference content summary, and determining, according to the speech mark information, text positions of speech contents to be spoken by the participants-to-speak in the conference content summary; and counting the conference summary identifier information sent by all the participants-to-speak, and generating a sequence of speakers according to a position sequence of the text positions of the speech contents to be spoken by the participants-to-speak in the conference content summary. The method determines the speech sequence according to the sequential relationship of the participants-to-speak in the logical sequence of the conference contents.

In this exemplary embodiment, the parsing and counting of the conference summary identifier information comprises: adding receive time stamps to the conference summary identifier information sent by all the participants-to-speak; and counting the conference summary identifier information sent by all the participants-to-speak, and if it is determined that the text positions of the speech contents to be spoken by a plurality of the participants-to-speak in the conference content summary are the same, according to a time sequence of the receive time stamps, performing sorting of the sequence of speakers on the conference summary identifier information of the plurality of the participants-to-speak having the same text position in the speech contents. In determining the speech sequence according to the sequential relationship of the participants-to-speak in the logical sequence of the conference contents, when a plurality of participants-to-speak mark the same keyword in the conference summary, that is, the same logical sequence of the conference content is generated, at this time, it is necessary to determine the time sequence of marking by the participants-to-speak by marking time stamps, and the participant-to-speak who has a temporally previous marking time speaks first, and the participant-to-speak who has a temporally subsequent marking time speaks later.

In this exemplary embodiment, the method further comprises: acquiring the speech mark information added by the participants-to-speak in the conference content summary and the identity information of the participants-to-speak from the conference summary identifier information; establishing correspondence relationships between speech mark information of the participants-to-speak, the identity information of the participants-to-speak and the sequence of speakers; and sending the correspondence relationships to the corresponding participants-to-speak. After the speech sequence of the participants-to-speak in the conference is generated, the speech sequence of the participants-to-speak can be sent to all the participants, so as to allow the participants-to-speak who need to speak to confirm their own speech sequence, to prepare their speeches in advance, and allow all participants, when listening to the discussion speech, to confirm the current speaker according to the speech sequence or mark speakers of interest and focus on the progression of the speech and to listen to the discussion speech purposefully.

In this exemplary embodiment, sending the correspondence relationships to the corresponding participants-to-speak comprises: sending, according to the identity information of the participants-to-speak in the correspondence relationships, the sequence of speakers and speech confirmation information to the participants-to-speak; and after receiving speech response instructions replied by the participants-to-speak, adjusting the sequence of speakers according to the speech response instructions. Further, after a participant-to-speak receives the speech sequence, a speech confirmation operation can be performed. If the speech is confirmed, the participant-to-speak sends speech confirmation information to determine his or her position in the speech sequence, and if there is a misoperation or a problem for which discussion and speech would otherwise be performed has been solved due to deeper understanding of the conference contents, the speech can be canceled and speech cancellation information will be sent, so that the speech arrangement for the corresponding keywords of the conference summary in the speech sequence will be deleted.

In this exemplary embodiment, the method further comprises: looking up, from the sequence of speakers, participants-to-speak whose numbers of speeches are greater than or equal to a preset number of times; and organizing all the speech mark information of the participants-to-speak whose numbers of speeches are greater than or equal to the preset number of times in the correspondence relationships, and deleting, from the speaker sequence, non-first speech sequence of the participants-to-speak whose numbers of speeches in the correspondence relationships are greater than or equal to the preset number of times. When discussion and speech is performed on all the conference contents or some of the conference paragraphs, problems often occur in which several speakers make multiple speeches or multiple distributed speeches of the same participant-to-speak in the speech sequence are interrupted due to marking of logical keywords by the logical sorting method, leading to the phenomenon where some participants-to-speak speak frequently in the conference, making it difficult for the speech content to be spoken coherently. Therefore, it is necessary to optimize the speech sequence by setting a preset number of speeches according to the conference contents and the length of the paragraph, and reducing numbers of speeches for speakers whose numbers of speeches are greater than or equal to the preset number of speeches, so as to achieve the purpose of concentrating speeches.

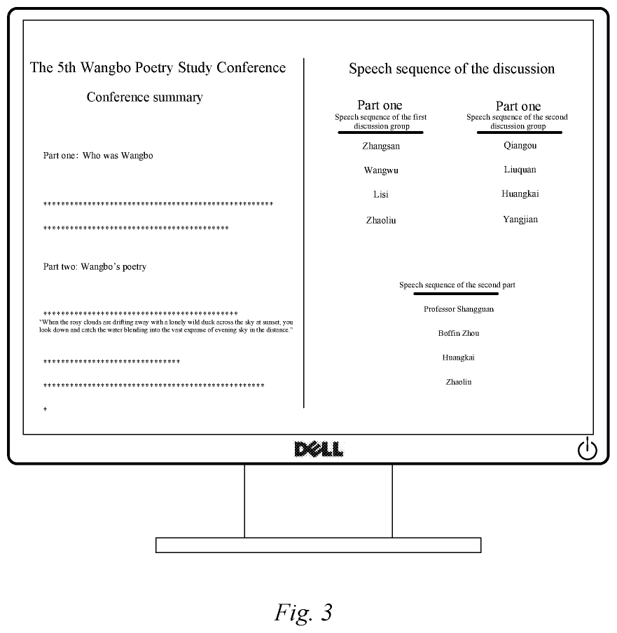

In this exemplary embodiment, the method further comprises: acquiring preset conference agenda information, and identifying time information in the conference agenda information; and generating, according to the conference agenda information and pre-stored conference content, a conference content summary of a specified part; establishing a conference discussion group corresponding to the conference content summary of the specified part; identifying the speech mark information added by the participants-to-speak in the conference content summary, and determining, according to the speech mark information, text positions of speech contents to be spoken by the participants-to-speak in the conference content summary; and counting the conference summary identifier information sent by all the participants-to-speak, and assigning the participants-to-speak for the speech mark information added in the conference content summary of the same specified part to a same discussion group. In a large-scale conference or a multi-themed conference, it is often necessary to set up a plurality of discussion groups regarding a plurality of different conference topics at a certain stage of the conference to perform group discussion. At this time, it is necessary to determine which group the participant-to-speak should be in, according to the speech mark information added to the conference content summary by the participants-to-speak, and thus generate discussion group information therefrom, and then send the discussion group information to all the participant members in the corresponding discussion group. As shown in FIG. 3, in a certain academic conference, the conference speech sequence is generated according to the summary of the academic conference, wherein in the first part of the conference, group discussions are performed, and the participants-to-speak in different discussion groups and their speech sequences are different.

In this exemplary embodiment, generating, according to the conference summary identifier information, a speech sequence of the participants-to-speak in a conference discussion comprises: acquiring the identity information of the participants-to-speak and preset conference agenda information, the conference agenda information including identity identifiers of the participants and a sequence of arrangement; counting information of all the participants-to-speak; matching the information of all the participants-to-speak with the conference agenda information; and performing speaker sorting on all the participants-to-speak according to the identity identifiers of the participants and the sequence of arrangement of the participants in the preset conference agenda information. In some conferences, because of the different identities of the participants, the speech sequence is adjusted. The identity identifiers of the participants in the preset conference agenda information are identified, and the sequence is sorted according to preset rules. As shown in FIG. 3, in a certain academic conference, the conference speech sequence is generated according to the summary of the academic conference, wherein in the second part of the conference, the identity identifier information of the participants-to-speak is taken into consideration, and the speech sequence of the participants-to-speak with higher academic achievements comes first.

It should be noted that even though various steps of the method in the present disclosure are described in a specific order in the drawing, this is not intended to require or imply that these steps must be executed in this specific order, or that the desired result can only be realized while all the steps shown must be executed. Additionally or alternatively, some steps can be omitted, a plurality of steps can be merged into one step for execution, and/or one step can be subdivided into a plurality of steps for execution.

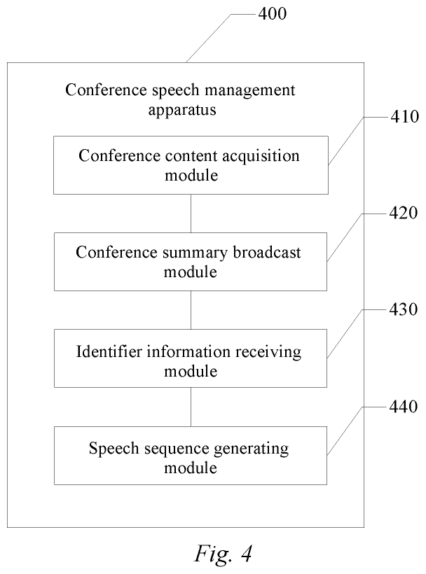

Furthermore, in this exemplary embodiment, a conference speech management apparatus is further provided. Referring to FIG. 4, the conference speech management apparatus 400 may comprise: a conference content acquisition module 410, a conference summary broadcast module 420, an identifier information receiving module 430, and a speech sequence generating module 440, wherein the conference content acquisition module 410 is used for acquiring conference contents and generating a conference content summary according to the conference contents;

the conference summary broadcast module 420 is used for broadcasting and sending the conference content summary to participants;

the identifier information receiving module 430 is used for receiving conference summary identifier information sent by the participants, marking the participants who send the conference summary identifier information as participants-to-speak, wherein the conference summary identifier information comprises speech mark information added by the participants-to-speak in the conference content summary and the identity information of the participants-to-speak; and

the speech sequence generating module 440 is used for parsing and counting the conference summary identifier information, and generating, according to the conference summary identifier information, a speech sequence of the participants-to-speak in a conference discussion.

The specific details of the modules of conference speech management apparatus above have been described in detail in the corresponding audio segment identification method, and thus will not be described herein.

It should be noted that although several modules or units of the conference speech management apparatus 400 are mentioned in the above detailed description, this division is not mandatory. Indeed, according to the embodiments of the present disclosure, the features and functions of two or more modules or units described above can be embodied in one module or unit. Conversely, the features and functions of one module or unit described above can be further divided into and embodied by a plurality of modules or units.

In addition, in an exemplary embodiment of the present disclosure, an electronic device capable of implementing the method described above is further provided.

A person skilled in the art can understand that each aspect of the present invention may be implemented as a system, a method or a program product.

Accordingly, each aspect of the present invention may be specifically implemented in the form of: an entirely hardware embodiment, an entirely software embodiment (including firmware, microcodes, etc.), or an embodiment incorporating hardware and software aspects, which may be collectively referred to herein as a “circuit”, “module”, or “system”.

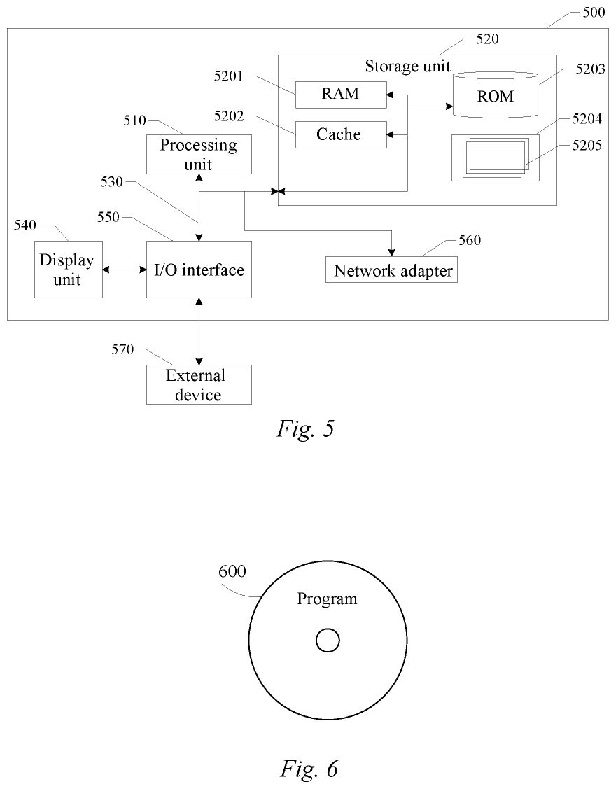

The electronic device 500 according to such embodiment of the present invention is described below with reference to FIG. 5. The electronic device 500 shown in FIG. 5 is merely an example and should not impose any limitation on the function and usage range of the embodiments of the present invention.

As shown in FIG. 5, the electronic device 500 is embodied in the form of a general purpose computing device. The components of the electronic device 500 may include, but are not limited to: the at least one processing unit 510, the at least one storage unit 520, a bus 530 for connecting different system components (including the storage unit 520 and the processing unit 510), and a display unit 540.

The storage unit stores program codes, which can be executed by the processing unit 510, such that the processing unit 510 performs the steps according to various exemplary embodiments of the present invention described in the “Exemplary Method” section of the description. For example, the processing unit 510 can perform steps S110 to S140 as shown in FIG. 1.

The storage unit 520 may comprise a readable medium in the form of a volatile storage unit, such as a random access memory (RAM) 5201 and/or a cache storage unit 5202, and may also further comprise a read only memory (ROM) 5203.

The storage unit 520 may also comprise a program/utility tool 5204 having a set of (at least one) program modules 5205, such program modules 5205 including but not limited to: an operating system, one or more application programs, and other program modules and program data, wherein each of or a certain combination of these examples may comprise the implementation of a network environment.

The bus 530 may be representative of one or more of several types of bus structures, including a storage unit bus or a storage unit controller, a peripheral bus, a graphics acceleration port, a processing unit, or a local area bus that uses any of a variety of bus structures.

The electronic device 500 may also communicate with one or more external devices 570 (such as, for example, a keyboard, a pointing device, a Bluetooth device), and may also communicate with one or more devices that enable a user to interact with the electronic device 500, and/or communicate with any device (such as, for example, a router, a modem) that enables the electronic device 500 to communicate with one or more other computing devices. This communication can be conducted via an input/output (I/O) interface 550. Also, the electronic device 500 can also communicate with one or more networks (for example, a local area network (LAN), a wide area network (WAN), and/or a public network, such as the Internet) via a network adapter 560. As shown in the drawing, the network adapter 560 communicates with other modules of the electronic device 500 via the bus 530. It should be understood that, although not shown in the drawing, other hardware and/or software modules may be utilized in conjunction with the electronic device 500, including but not limited to: microcodes, a device driver, a redundant processing unit, an external disk drive array, an RAID system, a tape drive, and a data backup storage system, and the like.

From the description of the embodiments above, it is easy for a person skilled in the art to understand that the exemplary embodiments described herein may be implemented in hardware, and may also be implemented in software in conjunction with necessary hardware. Therefore, the technical solutions according to the embodiments of the present disclosure may be embodied in the form of a software product. The software product may be stored in a non-volatile storage medium (which may be a CD-ROM, a USB flash disk, a mobile hard disk, and the like) or on a network, and may comprise several instructions to enable a computing device (which may be a personal computer, a server, a terminal apparatus, or a network device, and the like) to perform the method according to the embodiments of the present disclosure.

In exemplary embodiments of the present disclosure, a computer readable storage medium is further provided, having stored thereon a program product capable of implementing the method in the description. In some possible embodiments, various aspects of the present invention may also be implemented in the form of a program product comprising program codes for causing, when the program product is running on a terminal device, the terminal device to perform the steps according to various exemplary embodiments of the present invention described in the “Exemplary Method” section of the description.

Referring to FIG. 6, it describes a program product 600 for implementing the above method according to the embodiments of the present invention, which may employ a portable compact disk read only memory (CD-ROM) and comprise program codes, and may be running on a terminal device, for example a personal computer. However, the program product of the present invention is not limited thereto, and in this document, the readable storage medium may be any tangible medium containing or storing a program that can be used by or used in connection with an instruction execution system, apparatus or device.

The program product may employ any combination of one or more readable media. The readable medium may be a readable signal medium or a readable storage medium. The readable storage medium may be, for example, but not limited to, an electronic, magnetic, optical, electromagnetic, infrared, or semiconductor system, apparatus, or device, or any combination thereof. More specific examples of the readable storage media (a non-exhaustive list) comprise: an electrical connection having one or more wires, a portable disk, a hard disk, a random access memory (RAM), a read only memory (ROM), an erasable programmable read only memory (EPROM or flash), fiber optics, a portable compact disk read only memory (CD-ROM), an optical storage device, a magnetic storage device, or any suitable combination thereof.

The computer readable signal medium may comprise a data signal that is propagated in a baseband or as a part of a carrier, in which readable program codes are carried. Such propagated data signal may take a variety of forms, including, but not limited to, an electromagnetic signal, an optical signal, or any suitable combination thereof. The readable signal medium may also be any readable medium, other than a readable storage medium, that can send, propagate, or transmit a program for use by or use in connection with an instruction execution system, apparatus, or device.

The program code contained on the readable medium can be transmitted using any suitable medium, including but not limited to wireless, wired, optical cable, RF, etc., or any suitable combination thereof.

The program codes for performing the operations of the present invention may be written in any combination of one or more programming languages, wherein the programming languages comprise an object oriented programming language, such as Java, and C++, and further comprise conventional procedural programming languages, such as “C” language or similar programming languages. The program codes may be completely executed on a user computing device, partially executed on a user device, executed as an independent software package, executed partially on a user computing device and partially on a remote computing device, or completely executed on a remote computing device or a server. In the case of a remote computing device, the remote computing device can be connected to a user computing device via any kind of network, including a local area network (LAN) or a wide area network (WAN), or can be connected to an external computing device (for example, connected via the Internet with the aid of an Internet service provider).

In addition, the drawings above are merely schematic illustrations of the processing included in the method according to the exemplary embodiments of the present invention, and are not for limitation purpose. It is easy to understand that the processes shown in the drawings above do not represent or limit a time order of these processes. Additionally, it is also easy to understand that these processes may be performed synchronously or asynchronously, for example, in a plurality of modules.

Other embodiments of the present disclosure would readily occur to a person skilled in the art after considering the description and the practice of the invention disclosed herein. The present application is intended to cover any variation, usage or adaptation change of the present disclosure, which follow the general principles of the present disclosure and include common general knowledge or customary technical means in the art that are not disclosed in the present disclosure. The description and embodiments are merely to be regarded exemplary, while the true scope and spirit of the present disclosure are indicated by the claims.

It should be understood that the present disclosure is not limited to the precise structures described and shown in the accompanying drawings, and various modifications and changes may be made without departing from the scope thereof. The scope of the present disclosure is merely defined by the appended claims.

### INDUSTRIAL APPLICABILITY

On the one hand, a speech sequence of the participants is automatically generated by means of identification processing of the conference summary identifier information, thereby simplifying the conference organization process and optimizing the conference management mode; and on the other hand, through the introducing of optimization logic for identifying the identity identifiers of the participants-to-speak of the conference and adjusting the sequence of multiple speeches, the speech sequence of the conference thus generated is fair and reasonable, and has rules to follow, which not only avoids the phenomenon that the speakers in the common meetings are courteous to each other in presenting a speech, but also enables the participants to choose to participate with preference in the conference according to the speech sequence, thereby enhancing the user experience.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A conference speech management method, comprising:
a conference content acquisition step for acquiring conference contents and generating a conference content summary according to the conference contents;
a conference summary broadcast step for broadcasting and sending the conference content summary to participants;
an identifier information receiving step for receiving conference summary identifier information sent by participants, marking the participants who send the conference summary identifier information as participants-to-speak, wherein the conference summary identifier information comprises speech mark information added by the participants-to-speak in the conference content summary and the identity information of the participants-to-speak; and
a speech sequence generating step for parsing and counting the conference summary identifier information, and generating, according to the conference summary identifier information, a speech sequence of the participants-to-speak in a conference discussion.

2. The method of claim 1, wherein broadcasting and sending the conference content summary to the participant comprises:
acquiring conference agenda information;
identifying time information in the conference agenda information;
generating, according to the conference agenda information and pre-stored conference content, a conference content summary of a specified part;
determining specified time information in the conference agenda information corresponding to the conference content summary of the specified part;
setting a timer according to the specified time information; and
broadcasting, after a timing duration of the timer expires, the conference content summary of the specified part to the participants.

3. The method of claim 1, wherein the parsing and counting the conference summary identifier information comprises:
identifying the speech mark information added by the participants-to-speak in the conference content summary, and determining, according to the speech mark information, text positions of speech contents to be spoken by the participants-to-speak in the conference content summary; and
counting the conference summary identifier information sent by all the participants-to-speak, and generating a sequence of speakers according to a position sequence of the text positions of the speech contents to be spoken by the participants-to-speak in the conference content summary.

4. The method of claim 3, wherein the parsing and counting the conference summary identifier information comprises:
adding receive time stamps to the conference summary identifier information sent by all the participants-to-speak; and
counting the conference summary identifier information sent by all the participants-to-speak, and if it is determined that the text positions of the speech contents to be spoken by a plurality of the participants-to-speak in the conference content summary are the same, according to a time sequence of the receive time stamps, performing sorting of the sequence of speakers on the conference summary identifier information of the plurality of the participants-to-speak having the same text position in the speech contents.

5. The method of claim 4, further comprising:
acquiring the speech mark information added by the participants-to-speak in the conference content summary and the identity information of the participants-to-speak from the conference summary identifier information;
establishing correspondence relationships between speech mark information of the participants-to-speak, the identity information of the participants-to-speak and the sequence of speakers; and
sending the correspondence relationships to the corresponding participants-to-speak.

6. The method of claim 5, wherein sending the correspondence relationships to the corresponding participants-to-speak comprises:
sending, according to the identity information of the participants-to-speak in the correspondence relationships, the sequence of speakers and speech confirmation information to the participants-to-speak; and
after receiving speech response instructions replied by the participants-to-speak, adjusting the sequence of speakers according to the speech response instructions.

7. The method of claim 5, further comprising:
looking up, from the sequence of speakers, participants-to-speak whose numbers of speeches are greater than or equal to a preset number of times; and
organizing all the speech mark information of the participants-to-speak whose numbers of speeches are greater than or equal to the preset number of times in the correspondence relationships, and deleting, from the speaker sequence, non-first speech sequence of the participants-to-speak whose numbers of speeches in the correspondence relationships are greater than or equal to the preset number of times.

8. The method of claim 1, further comprising:
acquiring preset conference agenda information, and identifying time information in the conference agenda information; and
generating, according to the conference agenda information and pre-stored conference content, a conference content summary of a specified part;
establishing a conference discussion group corresponding to the conference content summary of the specified part;
identifying the speech mark information added by the participants-to-speak in the conference content summary, and determining, according to the speech mark information, text positions of speech contents to be spoken by the participants-to-speak in the conference content summary; and
counting the conference summary identifier information sent by all the participants-to-speak, and assigning the participants-to-speak for the speech mark information added in the conference content summary of the same specified part to a same discussion group.

9. The method of claim 1, wherein generating, according to the conference summary identifier information, a speech sequence of the participants-to-speak in a conference discussion, comprises:
acquiring the identity information of the participants-to-speak and preset conference agenda information, the conference agenda information including identity identifiers of the participants and a sequence of arrangement;
counting information of all the participants-to-speak;
matching the information of all the participants-to-speak with the conference agenda information; and
performing speaker sorting on all the participants-to-speak according to the identity identifiers of the participants and the sequence of arrangement of the participants in the preset conference agenda information.

10. A conference summary generating apparatus, comprising:
a conference content acquisition module for acquiring conference contents and generating a conference content summary according to the conference contents;
a conference summary broadcast module for broadcasting and sending the conference content summary to participants;
an identifier information receiving module for receiving conference summary identifier information sent by the participants, marking the participants who send the conference summary identifier information as participants-to-speak, wherein the conference summary identifier information comprises speech mark information added by the participants-to-speak in the conference content summary and the identity information of the participants-to-speak; and
a speech sequence generating module for parsing and counting the conference summary identifier information, and generating, according to the conference summary identifier information, a speech sequence of the participants-to-speak in a conference discussion.

11. An electronic device, comprising:
a processor; and
a memory having stored thereon computer readable instructions that, when executed by the processor, implement the method of claim 1.

12. A computer readable storage medium having stored thereon a computer program that, when executed by a processor, implements the method of claim 1.
